(19) United States
(12) Patent Application Publication
(10) Pub. No.: US 2016/0232516 A1
(43) Pub. Date: Aug. 11, 2016

(54) PREDICTIVE AUTHORIZATION OF MOBILE PAYMENTS

(71) Applicant: Google Inc., Mountain View, CA (US)

(72) Inventors: Tal Dayan, Los Gatos, CA (US); Maya Ben Ari, Palo Alto, CA (US)

(21) Appl. No.: 15/012,316

(22) Filed: Feb. 1, 2016

Related U.S. Application Data
(60) Provisional application No. 62/113,218, filed on Feb. 6, 2015.

(51) Int. Cl. G06Q 20/32

(52) U.S. Cl. CPC G06Q 20/3227

(57) ABSTRACT

A device is described that includes one or more processors, one or more sensors to generate sensor data, one or more communication units and one or more modules. The one or more modules are operable by the one or more processors to, prior to initiating a payment transaction, analyze the sensor data to determine a risk level for the payment transaction, and initiate the payment transaction with a payment system. The one or more modules are further operable by the one or more processors to determine a risk level threshold for the payment transaction, and selectively send, based on the risk level determined prior to the payment transaction and the risk level threshold and using the one or more communication units, authorization for the payment transaction.

This application claims the benefit of U.S. Provisional Application No. 62/113,218 filed Feb. 6, 2015, the entire content of which is hereby incorporated by reference.

### BACKGROUND

Mobile devices, such as smartphones, and wearable computing devices, such as computerized watches, may be promising platforms for payments, replacing the more traditional practices of cash, checks and credit cards. However, one of the challenges with the design of a mobile payment system is the balance between security and a hassle free user experience. Each of these two goals is achievable on its own at the expense of the other. For example, requiring a user to enter a password each time they pay electronically may result in a poor user experience. On the other hand, authorizing such payments without requiring authentication for each payment may create a potential for abuse by unauthorized persons and financial loss.

### SUMMARY

In one example, a device includes one or more processors, one or more sensors to generate sensor data, one or more communication units and one or more modules. The one or more modules are operable by the one or more processors to, prior to initiating a payment transaction, analyze the sensor data to determine a risk level for the payment transaction, and initiate the payment transaction with a payment system. The one or more modules are further operable by the one or more processors to determine a risk level threshold for the payment transaction, and selectively send, based on the risk level determined prior to the payment transaction and the risk level threshold and using the one or more communication units, authorization for the payment transaction.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system for predictively authorizing mobile payments, in accordance with one or more techniques of the present disclosure.

FIG. 2 is a block diagram illustrating an example system for predictively authorizing mobile payments when using a primary device and a secondary device, in accordance with one or more techniques of the present disclosure.

FIG. 3 is a block diagram illustrating an example mobile computing device for predictively authorizing mobile payments, in accordance with one or more techniques of the present disclosure.

FIG. 4 is a flow chart illustrating an example operation of a system for predictively authorizing mobile payments when using a primary device and a secondary device, in accordance with one or more techniques of the present disclosure.

### DETAILED DESCRIPTION

Techniques according to the disclosure may enable a computing device, such as a mobile computing device, wearable computing device, etc., to predictively authorize mobile payments such that a user may be able to make a mobile payment without requiting a user to input a response to an authentication challenge. In order to determine whether to predictively authorize a mobile payment, a computing device may monitor inputs from one or more sensors of the device, compare the sensor inputs to preconfigured sensor input patterns associated with an authorized user of the device to determine if the user attempting to make the mobile payment is an authorized user of the computing device. In addition, the computing device may perform a risk assessment (e.g., based on the likelihood that an authorized user is the one attempting to make the mobile payment and the relative cost of error if the mobile payment is incorrectly authorized) to determine whether or not the mobile payment should be authorized. Responsive to determining that the risk associated with authorizing the mobile payment satisfies a threshold amount of risk, the computing device may authorize the mobile payment transaction. In this way, techniques of this disclosure may enable a computing device to authorize a mobile payment without requiring a user to complete an explicit security challenge, thereby reducing the number of steps required to complete the mobile payment, which may result in a better user experience without significantly increasing the risk of abuse by unauthorized persons and financial loss.

Throughout the disclosure, examples are described where a computing device and/or a computing system may analyze information (e.g., locations, speeds, etc.) associated with a computing device only if the computing device receives permission from the user to analyze the information. For example, in situations discussed below in which the computing device may collect or may make use of information associated with the user, the user may be provided with an opportunity to provide input to control whether programs or features of the computing device can collect and make use of user information (e.g., information about a user's current location, current speed, motion, etc.), or to dictate whether and/or how to the computing device may receive content that may be relevant to the user. In addition, certain data may be treated in one or more ways before it is stored or used by the computing device and/or computing system, so that personally identifiable information is removed. For example, a user's identity may be treated so that no personally identifiable information can he determined about the user, or a user's geographic location may be generalized where location information is obtained (such as to a city, ZIP code, or state level), so that a particular location of a user cannot be determined. Thus, the user may have control over how information is collected about the user and used by the computing device.

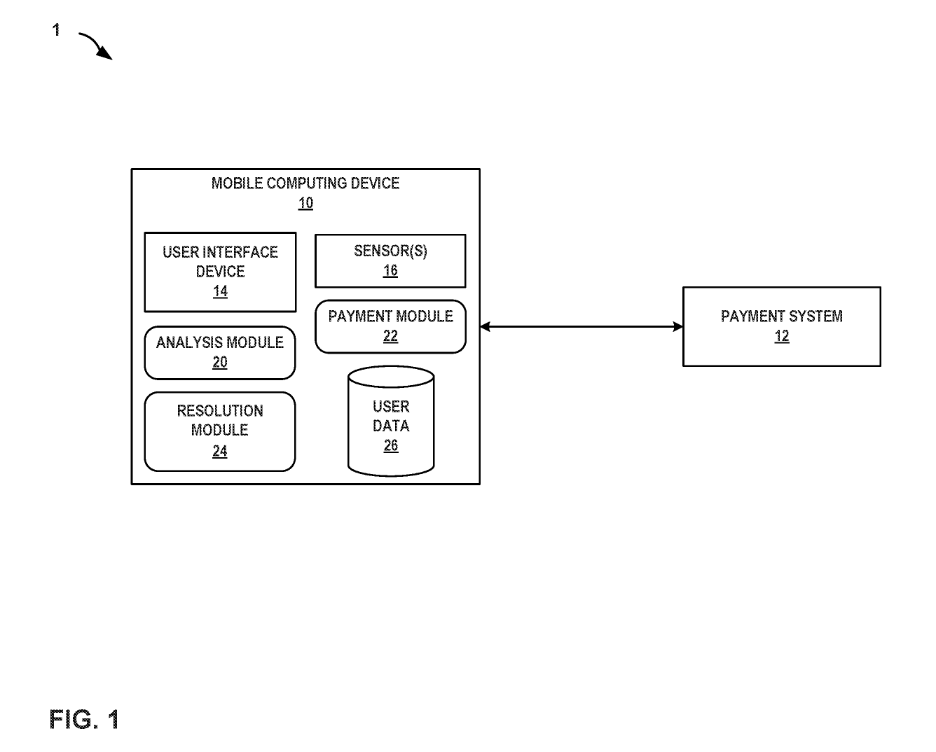

FIG. 1 is a block diagram illustrating an example system for predictively authorizing mobile payments, in accordance with one or more techniques of the present disclosure. As shown in the example of FIG. 1, system 1 includes mobile computing device 10 and payment system 12. In the example of FIG. 1, mobile computing device 10 includes at least one user interface (UI) device 14, one or more sensors 16, one or more processors 18, analysis module 20, payment module 22, resolution module 24, and user data 26. Other examples of mobile computing device 10 that implement techniques of this disclosure may include additional components not shown in FIG. 1. Examples of mobile computing device 10 may include, but are not limited to, portable devices such as mobile phones (including smart phones), laptop computers, tablet computers, cameras, personal digital assistants (PDAs), media players, e-book readers, etc. While analysis module 20, resolution module 24, and user data 26 are shown in the example of FIG. 1 as being located within mobile computing device 10, in other examples, all or part of the functionality provided by these elements may be delegated to a cloud computing system and/or a secondary mobile device.

Payment system 12 may be any payment device usable for processing mobile payment transactions. In some examples, payment system 12 may be a stand-alone device while, in other examples, payment system 12 may be a hardware accessory coupled to a different device or a software system installed on a device. In some instances, payment system 12 is a remote payment system associated with an online store. In general, payment system 12 may receive payment information from and/or transmit financial transaction information to another device. Typically, in mobile payment systems, the other device is a mobile device, such as mobile computing device 10, but is not so limited.

Mobile computing device 10 may communicate with payment system 12 when performing mobile payments. For example, mobile computing device 10 may receive transaction information from payment system, such as information about the payee (identity of the payee, location of the payment system, etc.), goods and/or services being purchased, price of the goods and/or services being purchased, etc. Mobile computing device 10 may also transmit information to payment system 12, including payment authorization for the pending transaction. When communicating with payment system 12, mobile computing device 10 may use wired or wireless communication mechanisms, such as Bluetooth, near-field communication (NFC), Wi-Fi, infrared, universal serial bus, Ethernet, cellular networks, etc.

A user associated with mobile computing device 10 can interact with mobile computing device 10 by providing various user inputs into mobile computing device 10, e.g., using at least one UI device 14. In some examples, the at least one UI device 14 is configured to receive tactile, audio, or visual input. In addition to receiving input from a user, UI device 14 can be configured to output content such as a graphical user interface (GUI) for display, e.g., at a display device associated with mobile computing device 10. In some examples, UI device 14 can include a display and/or a presence-sensitive input device. In some examples, the display and the presence-sensitive input device may be integrated into a presence-sensitive display, which displays the GUI and receives input from the user using capacitive, inductive, and/or optical detection at or near the presence sensitive display. In other examples, the display device can be physically separate from a presence-sensitive device associated with mobile computing device 10.

Analysis module 20 may receive information from one or more sensors 16 and store at least an indication of the information received from sensors 16 in user data 26. Sensors 16 may include motion sensors e.g., accelerometer, gyroscope, compass, etc.), audio and/or visual sensors (e.g., microphones, still and/or video cameras, etc.), or other types of sensors (e.g., pressure sensors, light sensors, proximity sensors, ultrasonic sensors, global positioning system sensors, etc.). User data store 26 may represent any suitable storage medium for storing data. For example, user data store 26 may store sensor information data received by analysis module 42 as well as exemplary sensor data patterns for users authorized to make mobile payments using mobile computing device 10.

Analysis module 20 may periodically or continually receive and store the sensor information. At least periodically, analysis module 20 analyzes the sensor information to determine a likelihood that the sensors information corresponds to an authorized user of mobile computing device 10. For example, analysis module 20 may apply an analysis of the sensor data, both the sensor data currently being received as well as the previously received sensor data (e.g., stored within a memory of mobile computing device 10 and/or within user data 26), and construct a risk metric. The risk metric may be a single risk metric for any mobile payment or may include multiple different risk metrics, each of which may be associated with a different category of mobile payment transaction. The analysis may be a machine learning algorithm, a rule base, a decision tree, mathematical optimization, or any other algorithm suitable for determining a likelihood that the sensor data corresponds an authenticated user of mobile computing device 10. In various instances, analysis module 20 may periodically store a determined risk metric in user data 26 for use in a future mobile payment transaction.

Payment module 22 may interface with payment system 12. When mobile computing device 10 is utilized to initiate a mobile payment, payment module 22 may receive transaction information, such as the amount of the transaction, a purpose of the transaction (e.g., payment, refund, etc.), an identity of the merchant, etc., and may request authorization from resolution module 24.

Resolution module 24 may determine whether or not the transaction is authorized based on the risk metric as well as the transaction information. For example, resolution module 24 may determine that the transaction is a purchase and that the transaction amount is greater than $1,000. As such, resolution module 24 may determine that a cost of incorrectly authorizing the transaction is relatively high. As a result, resolution module 24 may require the risk metric to satisfy a stricter threshold (i.e., require a higher likelihood that mobile computing device 10 is being used by an authorized user in order to authorize the transaction). As another example, resolution module 24 may determine that the transaction is a purchase and that the transaction amount is less than $10. Based on these determinations, resolution module 24 may determine that the cost of incorrectly authorizing the transaction is relatively low and require the risk metric satisfy a more lenient threshold (i.e., require a lower likelihood that mobile computing device 10 is being used by an authorized user in order to authorize the transaction). If resolution module 24 also determined that the current location of mobile computing device 10 is far away from a home of the user (e.g., 10 miles away) and the purchase is for a bus ticket, resolution module 24 may determine that the costs of incorrectly determining that the transaction is not authorized is relatively high, resolution module 24 may further reduce the threshold.

In some examples, resolution module 24 may also authorize the transaction based on prior transactions and other information stored in user data 26, as well as current location information, current time and date information, etc. For example, if a user typically visits a particular coffee shop on Monday mornings, resolution module 24 may determine that the current day is a Monday, the time of day is morning, and the location of mobile computing device 10 corresponds to the coffee shop. Moreover, resolution module 24 may determine that the amount of the transaction may be within a threshold of the average transaction for the user at this coffee shop. Based on these determinations, resolution module 24 may require a relatively low threshold for the risk metric to satisfy before authorizing the transaction. That is, resolution module 24 may alter the risk threshold based on sensor information, past user behavior, and transaction information.

In situations discussed throughout in which the computing device may collect or may make use of information associated with the user, the user may be provided with an opportunity to provide input to control whether programs or features of the computing device can collect and make use of user information (e.g., information about a user's current location, current speed, motion, purchase history, location history, etc.), or to dictate whether and/or how to the computing device may receive content that may be relevant to the user. In addition, certain data may be treated in one or more ways before it is stored or used by the computing device and/or computing system, so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device.

Resolution module 24 provides an indication of whether the transaction was authorized to payment module 22. If the transaction was authorized, payment module 22 transmits the payment information to payment system 12. If the transaction was not authorized, payment module 22 may cause user interface device 14 to output an indication as to why the transaction was not approved and may include a request for a user of mobile computing device 10 to perform an authentication challenge (e.g., to input security information, such as a password, a personal identification number (PIN), a pattern or biometric data (e.g., fingerprint, voice, image, or the like)). If the user successfully performs the authentication challenge, payment module 22 may transmit the payment information to payment system 12 and complete the transaction. In some examples, payment module 22 may store an indication that the transaction was authorized after the user completed the security challenge in user data 26 such that analysis module 20 and resolution module 24 may, for future transactions, improve the accuracy and reliability of the results of the risk metric and authorization. If the user does not successfully perform the authentication challenge, payment module 22 will reject the transaction and may refrain from sending payment information to payment system 12.

Analysis module 20 and resolution module 24 may also be user configurable. That is, a user of mobile computing device 10 may configure the risk level the user is willing to accept. For example, if the user configures mobile device 10 to be more willing to accept the risk of fraudulent transactions, then analysis module 20 alter the risk metric calculations to reflect a lower risk of erroneous authentication/rejection of a transaction. Similarly, resolution module 24 may make the risk threshold more lenient such that more transactions may be authorized.

In some examples, a merchant may be able to override the configured level of acceptable risk. For example, merchants that frequently experience fraudulent transactions may cause payment system 12 to send an indication of a higher risk threshold such that resolution module 24 may require a more stringent risk threshold before authorizing the transaction. Similarly, merchants that experience infrequent fraudulent transactions otherwise agrees to accept an increased chance of fraudulent activity, may cause payment system 12 to send an indication of a lower risk threshold such that resolution module 24 may require a more lenient risk threshold before authorizing the transaction.

Mobile computing device 10 may also be configured to detect theft and automatically stop authorizing all or a specified subset of transactions. For example, analysis module 20 may determine, based on accelerometer data from sensors 16, that mobile computing device 10 was grabbed and automatically significantly increase the risk metric such that resolution module 24 stops authorizing mobile payments. In some examples, analysis module 20 may send resolution module 24 an indication that mobile computing device 10 was likely stolen. Using this information, resolution module 24 may selectively authorize transactions, such as bus fare back to a home location of mobile computing device 10, while not authorizing other transactions, such as an online music purchase.

In this way, mobile computing device 10 may be configured to predictively authorize the mobile payment. That is, mobile computing device 10 may determine a risk metric prior to a user initiating a mobile payment transaction and use the predefined risk metric as well as other sensor information and past user behavior to authorize the mobile payment without requiring the user to complete a security challenge at the time of the transaction.

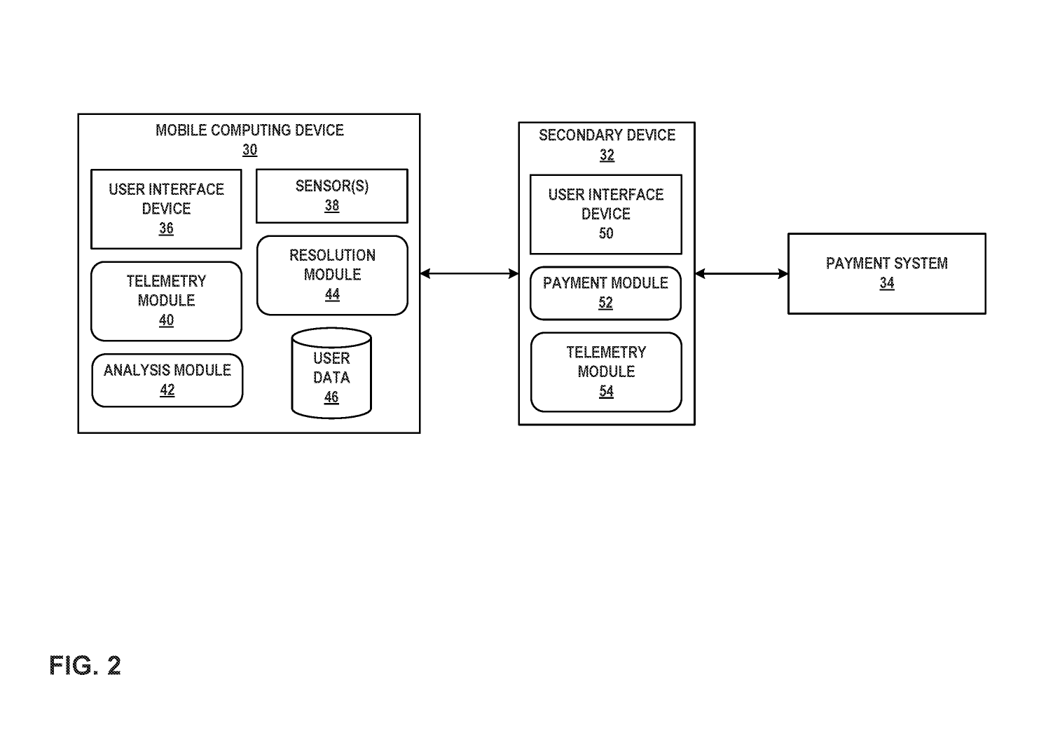

FIG. 2 is a block diagram illustrating an example system for predictively authorizing mobile payments when using a primary device and a secondary device, in accordance with one or more techniques of the present disclosure. As shown in FIG. 2, mobile computing device 30 is an example of a primary device and includes user interface device 36, one or more sensors 38, telemetry module 40, analysis module 42, resolution module 44, and user data 46. User interface device 36, sensors 38, analysis module 42, resolution module 44, and user data 46 may be similar to user interface device 14, sensors 16, analysis module 20, resolution module 24, and user data 26, respectively, as described with respect to FIG. 1. Examples of mobile computing device 30 may include, but are not limited to, portable devices such as mobile phones (including smart phones), laptop computers, tablet computers, cameras, personal digital assistants (PDAs), media players, e-book readers, etc. While analysis module 42, resolution module 44, and user data 46 are shown in the example of FIG. 2 as being located within mobile computing device 30, in other examples, all or part of the functionality provided by these elements may be delegated to a cloud computing system and/or secondary device 32. In addition, payment system 34 may be similar to payment system 12 as described with respect to FIG. 1.

Secondary device 32 may be any computerized device capable of exchanging transaction information with mobile computing device 30 and payment system 34. For example, secondary device 32 may be a wearable computing device, such as, a computerized watch, computerized glasses, a computerized glove, etc. Computerized devices (e.g., a computerized watch, computerized glasses, a computerized glove, etc.) may refer to any electrical computing device configured to store and process data. Electrical computing devices may include, for example, digital computers, analog computers, mobile computers, optical computers, quantum computers, or the like. In some examples, computerized devices may include, for example, at least one processing element (e.g., CPU) and memory (e.g., non-volatile memory, volatile memory, etc.). In some examples, secondary device 32 may be a mobile computing device. As shown in FIG. 2, secondary device 32 includes user interface device 50, payment module 52, and telemetry module 54. User interface device 50 and payment module 52 may be similar to user interface device 14 and payment module 22, respectively, as described with respect to FIG. 1.

Telemetry module 40 of mobile computing device 30 and telemetry module 54 of secondary device 32 may be used to communicate with external devices via one or more networks, such as one or more wireless networks. Examples of such wireless networks may include Bluetooth, 3G, LTE, and Wi-Fi wireless networks. In some examples, secondary device 32 utilizes telemetry module 54 to wirelessly communicate with mobile computing device 30.

Mobile computing device 30 may monitor information generated by sensors 38. For example, analysis module 42 may monitor sensor information (e.g., motion data (e.g., accelerometer, gyroscope, and compass data indicative of motion of mobile computing device 30), audio, visual, global positioning system, etc.) and store the sensor information in user data 46. In some examples, analysis module 42 may also analyze application usage information, such as the duration, frequency, location, time, etc., of various applications installed at or otherwise executable by mobile computing device 30. At least periodically, analysis module 42 analyzes the sensor information to determine a likelihood that the sensor information corresponds to an authorized user of mobile computing device 10. For example, analysis module 42 may apply an analysis of the sensor data, both the sensor data currently being received as well as the previously received sensor data (e.g., stored within a memory of mobile computing device 10 and/or within user data 26), and construct a risk metric. In some examples, secondary device 32 may include sensors, user data, an analysis module, and/or a resolution module similar to mobile computing device 30 and the analysis module of secondary device 32 may monitor information (e.g., sensor information generated by sensors of secondary device 32, application usage information, user data stored in secondary device 32, or the like) to determine a likelihood that the information corresponds to an authorized user of secondary device 32 and/or mobile computing device 30.

The risk metric may be a single risk metric for any mobile payment or may include multiple different risk metrics, each of which may be associated with a different category of mobile payment transaction. The analysis may be a machine learning algorithm, a rule base, a decision tree, mathematical optimization, or any other algorithm suitable for determining a likelihood that the sensor data corresponds an authenticated user of mobile computing device 10. In various instances, analysis module 20 may periodically store a determined risk metric in user data 26 for use in a future mobile payment transaction. In some examples, an analysis module of secondary device 32 may periodically store a determined risk metric in a user data of secondary device 32 for use in a future mobile payment transaction.

Payment module 52 may interface with payment system 34. For example, in response to telemetry module 54 receiving a payment request from payment system 34, payment module 52 may determine payment information stored in user data of secondary device 32 for telemetry module 54 to send to payment system 34. When secondary device 32 is utilized to initiate a mobile payment, payment module 52 may receive transaction information, such as the amount of the transaction, a purpose of the transaction (e.g., payment, refund, etc.), an identity of the merchant, etc., and may request authorization from resolution module 44 of mobile computing device 30.

In some examples, secondary device 32 may include an analysis module and/or a resolution module that may be used to permit secondary device 32 to determine whether to send payment information without an authentication challenge (e.g., using mobile computing device 30, using secondary device 32, etc.) or to require satisfaction of an authentication challenge before sending payment information. Resolution module 44 and/or a resolution module of secondary device 32 may determine whether or not the transaction is authorized based on a combination of one or more of the risk metric determined by analysis module 42 and/or an analysis module of secondary device 32, the transaction information, and prior user behavior. Resolution module 44 and/or a resolution module of secondary device 32 may determine that the transaction is authorized, rejected, or requires reauthorization. In some instances, a user may select a risk level. For example, resolution module 44 and/or a resolution module of secondary device 32 may compare a determined risk metric and a user selected risk level (e.g., stored in user data 46, stored in a user data of secondary device 32, stored in a cloud computing system, etc.) in order to determine that a transaction is authorized, rejected, or requires reauthorization. As an example, a user that desires to minimize the potential for abuse by unauthorized persons may select a low risk level and the resolution module 44 and/or a resolution module of secondary device 32 may authorize only transactions where the determined risk metric is below the selected low risk level.

If reauthorization is required, resolution module 44 and/or a resolution module of secondary device 32 can further determine if a higher level of reauthorization (i.e., greater security measure required), which may detract from the user experience, or a lower level of reauthorization (i.e., lower security measure required), which may result in a smoother user experience. In order to satisfy the lower level reauthorization requirement, resolution module 44 and/or a resolution module of secondary device 32 may use less secure data, such as GPS location information, network neighborhood information determined using Wi-Fi, etc. In order to satisfy the higher level reauthorization requirement, resolution module 44 and/or a resolution module of secondary device 32 may use more reliable data for particularly identifying the user of mobile computing device 30 and secondary device 32, such as fingerprint data, audio data for voice recognition, passwords, pin patterns, visual data for facial recognition, motion data (e.g., when requiring the user to perform a particular gesture using either mobile computing device 30 or secondary device 32), etc. While the various types of data are described as being used for lower level or higher level reauthorization requirements, any of the various types of data may be used for either or both levels of reauthorization requirement and a user may configure which types of data may be used for each level of reauthorization requirement.

In some examples, a security challenge required to reauthorize the user may be performed using either mobile computing device 30 or secondary device 32. For example, if resolution module 44 requires the user to enter a password in order to reauthorize the user, the user may be able to enter the password by providing input to secondary device 32, which transmits the input to mobile computing device 30. As another example, the user may place his/her finger on a fingerprint sensor of secondary device 32 and secondary device 32 may generate the fingerprint information and provide it to resolution module 44.

While described as secondary device 32 requiring mobile computing device 30 to complete a transaction, in some examples, secondary device 32 may authorize a transaction without communicating with mobile computing device 30. For example, after completing a transaction, mobile computing device 30 may provide authorization to secondary device 32 to authorize certain transactions. The pre-authorized transactions may include transactions performed within a certain amount of time from the last transaction authorized by mobile computing device 30. In examples where secondary device 32 is a wearable computing device, the pre-authorized transactions may also include transactions performed while secondary device 32 determines that the user is continuing to wear secondary device 32 such that, if user removes secondary device 32, secondary device 32 must receive authorization from mobile computing device 30 prior to authorizing any other transactions. Additionally or alternatively, the pre-authorized transactions may include transactions performed while secondary device 32 determines that mobile computing device 30 and secondary device 32 are proximate, for example, such that communications messages sent via one or more short range communication protocols (e.g., Bluetooth, NFC, Wi-Fi, or the like) are received by the telemetry module 54. In some examples, the pre-authorized transactions may include transactions performed while secondary device 32 determines that mobile computing device 30 is in a trusted state (e.g., in response to mobile computing device 30 receiving an input satisfying an authentication challenge, in response to a reauthorization of mobile computing device 30, or the like). In some instances, telemetry module 54 may, in response to an analysis module and/or a resolution module of secondary device 32 determining that mobile computing device 30 and secondary device 32 are proximate, determining mobile computing device 30 is in a trusted state, and determining that secondary device 32 is in a worn state, send payment information to payment system 34. In some instances, secondary device 32 may initiate an authentication challenge and, in response to determining that an input satisfies the authentication challenge, secondary device 32 may authorize a transaction (e.g., sending payment information for the payment request, instructing mobile computing device 30 to send payment information, etc.) without communicating with mobile computing device 30.

In some examples, secondary device 32 may be a computing device (e.g., wearable computing device, mobile computing device, etc.) that may be primarily associated with someone other than an authorized user of mobile computing device 30. For example, secondary device 32 may be a primary device for another person, such as a spouse, child, sibling, other relative, friend, or other person. In such examples, secondary device 32 may include additional elements similar to those included in mobile computing device 30, such as sensors, analysis and resolution modules, and a data store for user data.

The authorized user of mobile computing device 30 may provide payment information (e.g., credit card information, banking account numbers, payment system authentication credentials, etc.) to secondary device 32. That is, the person for whom secondary device 32 is a primary device may share payment information with the authorized user of mobile computing device 30. Prior to authorizing a transaction, such as a mobile payment, secondary device 32 may analyze sensor information generated by sensors of secondary device 32 to determine whether a current user of secondary device 32 is the authorized user of mobile computing device 30, the primary user of secondary device 32, or another user. Further, in some examples, the person that entered the payment information may be different from the authorized user of mobile computing device 30. Secondary device 32 may determine if the current user of secondary device 32 is the person that provided the payment information to secondary device 32. In some examples, secondary device 32 may also analyze the sensor information to determine if the current user of secondary device 32 is a child or an adult.

An analysis module of secondary device 32 may use the information determined about the current user of secondary device 32 to determine the risk metric. For example, if the current user of secondary device 32 is a child, the analysis module may determine that a cost associated with a false positive is greater than if the current user were an adult and may determine that the risk metric should be higher. As another example, if the current user of secondary device 32 is the same user that provided the payment information to secondary device 32, the analysis module may determine that the risk metric should be lower. The analysis module of secondary device 32 may use sensor data to determine a current user. For example, secondary device 32 may include one or more sensors touch-sensitive screen, presence-sensitive display, touch-sensitive screen, mouse, keyboard, voice responsive system, video camera, microphone, or the like) that receive a user input (e.g., a password, a personal identification number (PIN), a pattern, biometric data, or the like) and the analysis module of secondary device 32 may select a current user (e.g., child, spouse, or the like) in response to the user input. The analysis module of secondary device 32 may use telemetry module 54 to determine a current user. For example, secondary device 32 may send a communication message using telemetry module 54 to a remote device (e.g., server, cloud computing system, mobile device, computing device, or the like) indicating information (e.g., a received user input, GPS location information, sensor data, or the like) and telemetry module 54 may receive an indication of the current user from the remote device.

A resolution module of secondary device 32 may also utilize the information determined about the current user of secondary device 32 to determine whether a transaction should be authorized, rejected, or if reauthorization is required. For example, if the current user of secondary device 32 is a spouse of the authorized user of mobile computing device 30, the resolution module may apply a more lenient threshold to the risk metric, thereby authorizing additional transactions that may not be authorized if the current user of secondary device 32 were a child. In addition, the resolution module may implement a time window in which all similar transactions to the authorized transactions are automatically authorized without requiring reauthorization. In instances where the current user is the authorized user of mobile computing device 30, a spouse, or other adult primary user of secondary device 32, the resolution module may implement a longer time window than if the current user is a child or an unknown user of secondary device 32.

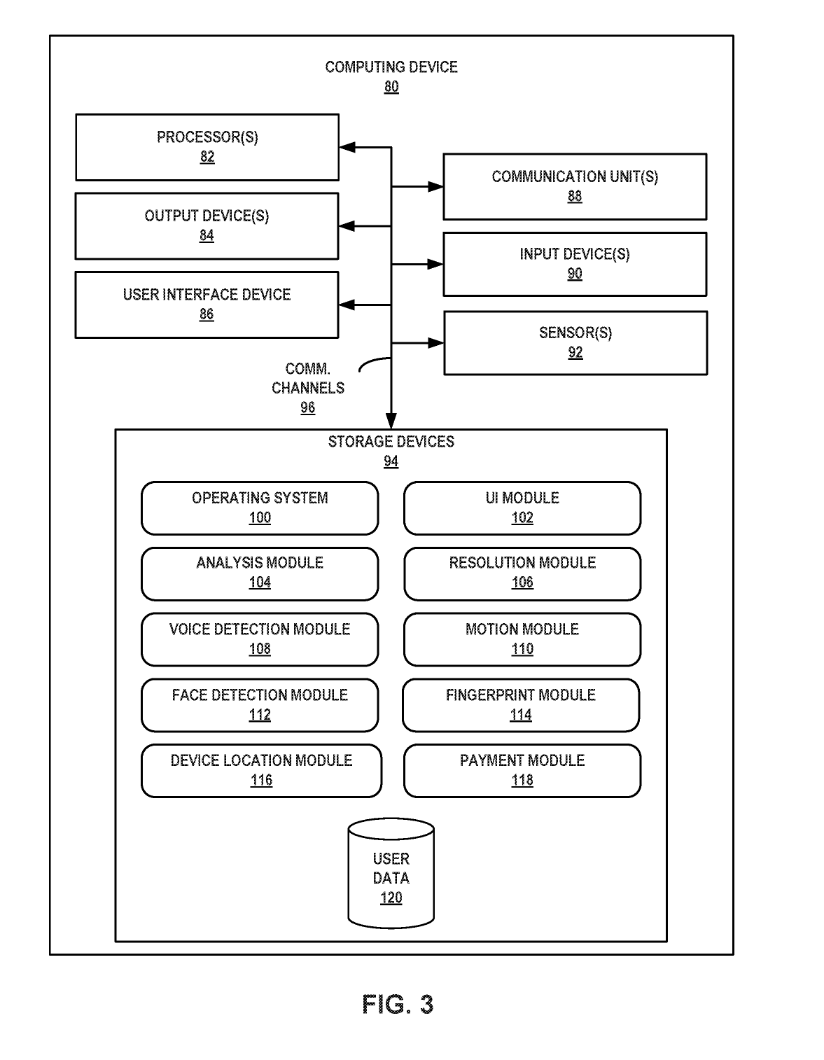

FIG. 3 is a block diagram illustrating an example mobile computing device for predictively authorizing mobile payments, in accordance with one or more techniques of the present disclosure. Computing device 80 of FIG. 3 is described below within the context of FIG. 1. FIG. 3 illustrates only one particular example of computing device 80, and many other examples of computing device 80 may be used in other instances and may include a subset of the components included in example computing device 80 or may include additional components not shown in FIG. 3.

As shown in the example of FIG. 3, computing device 80 includes one or more processors 82, one or more output devices 84, user interface device 86 (“UID 86”), one or more communication units 88, one or more input devices 90, one or more sensors 92, and one or more storage devices 94. Storage devices 94 of computing device 80 also include operating system 100, UI module 102, analysis module 104, resolution module 106, voice detection module 108, motion module 110, face detection module 112, fingerprint module 114, device location module 116, payment module 118, and user data 120. Analysis module 104, resolution module 106, and payment module 118 may be similar to analysis module 20, resolution module 24, and payment module 22 of FIG. 1. Computing device 80 can include additional components that, for clarity, are not shown in FIG. 3. For example, computing device 80 can include a battery to provide power to the components of computing device 80. Similarly, the components of computing device 80 shown in FIG. 3 may not be necessary in every example of computing device 80. For example, in some configurations, computing device 80 may not include output devices 84.

Communication channels 96 may interconnect each of the components 82, 84, 86, 88, 90, 92 and 94 for inter-component communications (physically, communicatively, and/or operatively). In some examples, communication channels 96 may include a system bus, a network connection, an inter-process communication data structure, or any other process for communicating data.

One or more processors 82 may implement functionality and/or execute instructions within computing device 80. For example, processors 82 on computing device 80 may receive and execute instructions stored by storage devices 94 that execute the functionality of modules 102-118. These instructions executed by processors 82 may cause computing device 80 to read/write/etc. information, such as one or more data files stored within storage devices 94 during program execution. Processors 82 may execute instructions of modules 102-118 to cause UID 86 to output one or more graphical indications of incoming communications for display at UID 86 as content of a user interface. That is, modules 102-118 may be operable by processors 82 to perform various actions or functions of computing device 80, for instance, causing UID 86 to a present a graphical user interface at UID 86.

One or more communication units 88 of computing device 80 may communicate with external devices via one or more wired and/or wireless networks using one or more wired or wireless networking protocols by transmitting and/or receiving network signals on the one or more networks. Examples of communication unit 88 include a network interface card (e.g. such as an Ethernet card), an optical transceiver, a radio frequency transceiver, a GPS receiver, Bluetooth, Wi-Fi, NFC (including active or passive), other active or passive short range communication circuitry, or any other type of device that can send and/or receive information. Other examples of communication units 88 may include short wave radios, cellular data radios, wireless network radios, as well as universal serial bus (USB) controllers.

One or more output devices 84 of computing device 80 may generate output. Examples of output are tactile, audio, and video output. Output devices 84 of computing device 80, in one example, includes a presence-sensitive display, sound card, video graphics adapter card, speaker, cathode ray tube (CRT) monitor, liquid crystal display (LCD), or any other type of device for generating output to a human or machine.

One or more input devices 90 of computing device 80 receive input. Examples of input are tactile, audio, and video input. Input devices 90 of computing device 80, in one example, includes a presence-sensitive display, touch-sensitive screen, mouse, keyboard, voice responsive system, video camera, microphone, or any other type of device for detecting input from a human or machine.

In some examples, UID 86 of computing device 80 may include functionality of input devices 90 and/or output devices 84. In the example of FIG. 3, UID 86 may be or may include a presence-sensitive input device. In some examples, a presence sensitive input device may detect an object at and/or near a screen. As one example range, a presence-sensitive input device may detect an object, such as a finger or stylus that is within 2 inches or less of the screen. The presence-sensitive input device may determine a location (e.g., an (x,y) coordinate) of a screen at which the object was detected. In another example range, a presence-sensitive input device may detect an object six inches or less from the screen and other ranges are also possible. The presence-sensitive input device may determine the location of the screen selected by a user's finger using capacitive, inductive, and/or optical recognition techniques. In some examples, presence sensitive input device also provides output to a user using tactile, audio, or video stimuli as described with respect to output device 84, e.g., at a display. In the example of FIG. 3, UID 86 presents a graphical user interface, such as graphical user interfaces 14 of FIG. 1.

While illustrated as an internal component of computing device 80, UID 86 also represents and external component that shares a data path with computing device 80 for transmitting and/or receiving input and output. For instance, in one example, UID 86 represents a built-in component of computing device 80 located within and physically connected to the external packaging of computing device 80 (e.g., a screen on a mobile phone). In another example, UID 86 represents an external component of computing device 80 located outside and physically separated from the packaging of computing device 80 (e.g., a monitor, a projector, etc. that shares a wired and/or wireless data path with a tablet computer).

Sensors 92 may be configured to detect one or more objects in proximity to computing device 80, measure the movement of computing device 80, and may collect other information associated with computing device 80. Examples of sensors 92 that detect and/or measure movement of computing device 80 may include, but are not limited to, accelerometers and gyroscopes. For instance, sensors 92 may be configured to measure the position, rotation, velocity, and/or acceleration of computing device 80. Sensors 92 may also include a clasp sensor (e.g., in examples where computing device 80 is a wearable computing device having a clasp), a galvanic skin response sensor, and any other type of sensor capable of collecting information related to computing device 80.

One or more storage devices 94 within computing device 80 may store information for processing during operation of computing device 80 (e.g., computing device 80 may store data that modules 102-118 may access during execution at computing device 80, including user data 120). In some examples, storage device 94 is a temporary memory, meaning that a primary purpose of storage device 94 is not long-term storage. Storage devices 94 on computing device 10 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 94, in some examples, also include one or more computer-readable storage media. Storage devices 94 may be configured to store larger amounts of information than volatile memory. Storage devices 94 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 94 may store program instructions and/or information (e.g., data) associated with modules 102-118 and operating system 100.

Operating system 106, in some examples, controls the operation of components of computing device 80. For example, operating system 106, in one example, facilitates the communication of modules 1100-118 with processors 82, one or more output devices 84, user interface device 86 (“UID 86”), one or more communication units 88, one or more input devices 90, and one or more sensors 92. Modules 102-118 may each include program instructions and/or data that are executable by computing device 80 (e.g., by one or more processors 82). As one example, analysis module 104, resolution module 106, and payment module 118 can each include instructions that cause computing device 80 to perform one or more of the operations and actions described in the present disclosure.

UI module 100 may cause UID 86 to output a graphical user interface for display, as a user of computing device 80 views output and/or provides input at UID 86. UI module 100 and UID 86 may receive one or more indications of input from a user as the user interacts with the graphical user interface, at different times and when the user and computing device 80 are at different locations. UI module 100 and UID 86 may interpret inputs detected at UID 86 (e.g., as a user provides one or more gestures at one or more locations of UID 86 at which the graphical user interface is displayed) and may relay information about the inputs detected at UID 86 to one or more associated platforms, operating systems, applications, and/or services executing at computing device 80, to cause computing device 80 to perform functions.

UI module 100 may receive information and instructions from one or more associated platforms, operating systems, applications, and/or services executing at computing device 80 for generating a graphical user interface. In addition, UI module 100 may act as an intermediary between the one or more associated platforms, operating systems, applications, and/or services executing at computing device 80 and various output devices of computing device 80 (e.g., speakers, LED indicators, audio or electrostatic haptic output device, etc.) to produce output (e.g., a graphic, a flash of light, a sound, a haptic response, etc.) with computing device 80.

Computing device 80 may receive, via communication units 88, an incoming message (e.g., from payment system 12 of FIG. 1) in response to a user of computing device 80 initiating a mobile payment transaction. For example, computing device 80 may receive transaction information from payment system 12, such as information about the payee (identity of the payee, location of the payment system, etc.), goods and/or services being purchased, price of the goods and/or services being purchased, etc. UI module may output an indication of the pending transaction (e.g., using user interface device 86 and/or one of output devices 84). Payment module 118 may receive the transaction information and initiate a payment authorization procedure by providing at least a portion of the transaction information to resolution module 106. Resolution module 106 may query analysis module 104 to determine the current risk level for processing transactions. Analysis module 104 determines the current risk level prior to receiving the query from resolution module 106 such that the current risk level is a predicted risk level associated with a future mobile payment transaction.

In order to determine the current risk level, analysis module 104 may analyze information received from one or more of modules 108-116 as well as information stored by user data 120. For example, voice detection module 108 may analyze audio samples collected by one of input devices 90 (e,g., a microphone) and compare the audio samples to stored voice samples for authorized users of computing device 80 to determine if the current user of computing device 80 is an authorized user (e.g., a user associated with the payment information, a user authorized to use the payment information, etc.). Voice detection module 108 may provide the result of the comparison to analysis module 104 for use in determining the risk level. For example, if the voice comparison indicates that the current user is not an authenticated user, analysis module 104 may increase the current risk level and vice versa.

As another example, motion module 116 may analyze motion data generated by sensors 92, such as accelerometer, gyroscope, and compass data indicative of motion of computing device 80. In some instances, motion module 116 may compare at least a portion of the motion data to stored motion data of an authorized user (e.g., template motion data). For example, motion module 116 may compare accelerometer data collected while the current user of computing device 80 is walking and compare it to stored accelerometer data of an authorized user of computing device 80 to see if the gait of the current user matches or is within a threshold margin of error of the gate of the authorized user. Motion module 116 may provide the result of this comparison to analysis module 104. For example, if the gait of the current user corresponds to an authenticated user, analysis module 104 may decrease the risk level, and vice versa.

Analysis module 104 may also use information from device location module 116 in determining the current risk level. Device location module 116 may receive location information from one of sensors 92 (e.g., a GPS sensor) and determine the location of computing device 80 at the time analysis module 104 is generating the risk level, which may he before initiation of the mobile payment transaction. In some examples, device location module 116 may determine whether the current location of computing device 80 is a location frequented by an authorized user of computing device 80. For example, if computing device 80 is at a location corresponding to a workplace of the recipient, device location module 116 may determine that the location corresponds to a location frequented by an authorized user. Based on this determination, analysis module 104 may decrease the current risk level. As another example, if computing device 80 is at a location corresponding to a bar not frequented by an authorized user, device location module 116 may determine that he location does not correspond to a location frequented by an authorized user. Based on this determination, analysis module 104 may increase the current risk level.

Analysis module may also analyze application usage patterns, such as the duration, frequency, location, time, etc., of various applications installed at or otherwise executable by computing device 80 and store the application usage information at user data 120. When determining the risk level, analysis module 104 may compare the application usage pattern for a recent time window (e.g., within the last 5 minutes, 30 minutes, hour, 2 hours, etc.) to prior application usage patterns for a corresponding time, day, location, etc. If the current application usage pattern is sufficiently similar (i.e., within a threshold amount different) of the corresponding prior application usage pattern, analysis module 104 may reduce the current risk level, and vice versa.

Resolution module 106 may use additional information received from one or more of modules 108-118 and information stored by user data 120 as well as the transaction information to adjust a risk threshold applied to the risk level when determining whether to authorize the transaction. In some examples, resolution module 106 may query user data 120 to retrieve past user behavior data for comparison to the current user behavior in order to determine whether the current mobile payment transaction is a typical mobile payment transaction. The past user behavior data may include location information, merchant information, transaction amount information, date and time information, etc. Resolution module 106 may compare such information to information received from one or more of modules 108-118 as well as the risk level received from analysis module 104 in order to determine whether to authorize, reject, or require reauthorization (including which level of reauthorization is required, such as low or high security level reauthorization).

For example, resolution module 106 may receive a current location of computing device 80 from device location module 116 and compare the current location to previous locations of computing device 80 retrieved from user data 120. If the current location does not correspond to a location computing device 80 previously visited or infrequently visited as determined based on the previous location information, resolution module 106 may increase the risk threshold, thus making it less likely that the transaction will be authorized without at least some level of reauthorization.

As another example, face detection module 112 may receive image data captured by one of input devices 90 (e.g., video data, still image data, etc. captured by a camera and determine if the image data includes one or more individuals. In some examples, face detection module 114 may determine if the image data includes one or more faces. If the image data includes the face of an authorized user, face detection module 114 may determine that the authorized user is currently using computing device 80. If the image data does not include the face of an authorized user, face detection module 114 may determine that an authorized user is not currently using computing device 80. In either instance, face detection module 114 may provide a result of the determination to resolution module 106. Resolution module 106 may decrease the risk threshold in response to face detection module 114 determining that an authenticated user is currently using computing device 80 and vice versa.

Resolution module 106 may also use information received from fingerprint module 114 to determine whether or not to authorize the transaction. Fingerprint module 114 may receive fingerprint information from a sensor 92 (e.g., a fingerprint sensor) and/or user interface device 86 (i.e., in examples where user interface device includes a presence-sensitive input device capable of capturing a fingerprint). Fingerprint module 114 may compare the fingerprint information to stored fingerprint information of an authorized user of computing device 80. If the captured fingerprint information sufficiently matches the stored fingerprint information, fingerprint module 114 provides, to resolution module 106, an indication that the current user of computing device 80 is an authenticated user. Similarly, if the captured fingerprint information does not match, fingerprint module 114 provides, to resolution module 106, an indication that the current user is not an authenticated user. Resolution module 106 adjusts the risk threshold based on the result of the comparison received from fingerprint module 114 (i.e., increasing the risk threshold if the user is not an authenticated user and vice versa).

In examples where resolution module 106 determining that reauthorization is required, resolution module 106 may cause UI module 102 to output instructions for the current user of computing device 80 to complete a security challenge and how to complete the security challenge. Depending on the security challenge, the user may be required to submit to a facial recognition process, provide a fingerprint for fingerprint authentication, enter a passcode, perform an input pattern, provide a voice sample for voice authentication, move computing device 80 in a particular pattern, etc. Regardless of the security challenge required, resolution module 106 may use information from one or more of modules 108-116 to complete the reauthorization and determine whether or not the transaction will be authorized.

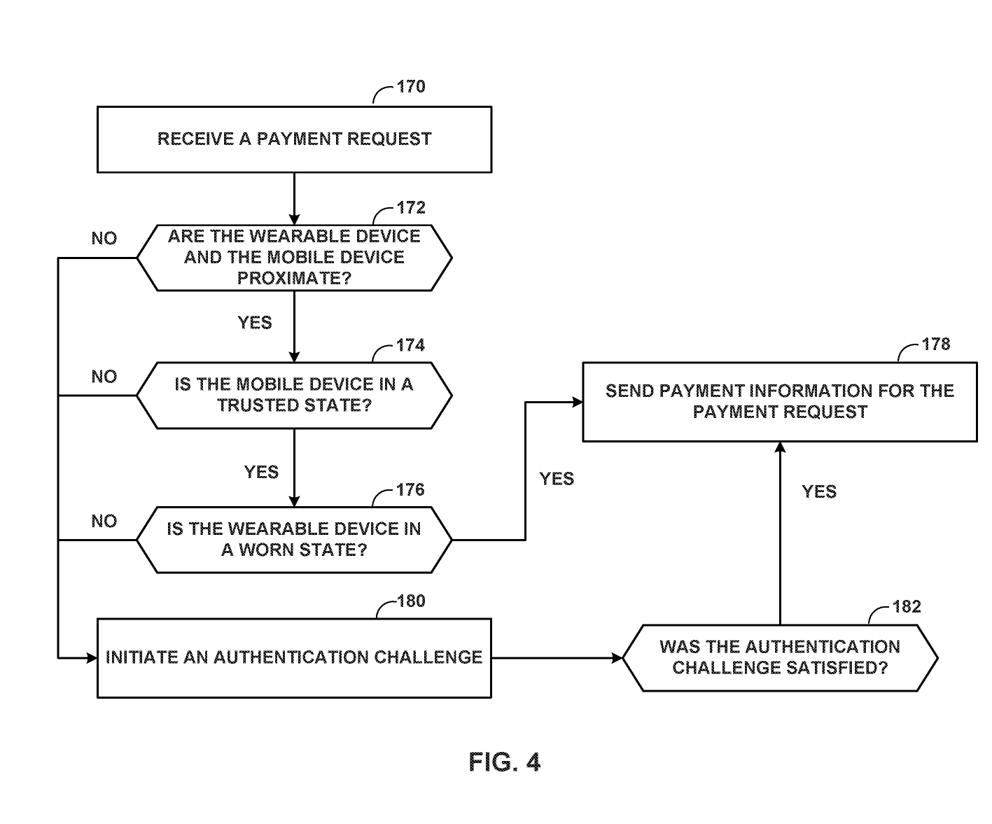

FIG. 4 is a flow chart illustrating an example operation of a system for predictively authorizing mobile payments when using a primary device and a secondary device, in accordance with one or more techniques of the present disclosure. While the operation is discussed with respect to the example of mobile computing device 30, secondary device 32, and payment system 34 of FIG. 2, it should be understood that the example operation shown in FIG. 4 may be carried out by other devices as well. As an example, one or more steps of the example operation shown in FIG. 4 may be carried out using computing device 80 of FIG. 3. It should also be understood that some steps illustrated in the flow chart may be optional. As one example, an authentication challenge may be omitted.

In the example of FIG. 4, secondary device 32 (e.g., a wearable computing device such as, for example, a computerized watch, computerized glasses, a computerized glove, etc.) may receive a payment request (170). For example, in response to a user placing secondary device 32 near a payment device of payment system 34, telemetry module 54 of secondary device 32 may receive a payment request for a purchase from payment system 34 using a Bluetooth protocol, NFC protocol, or the like.

Secondary device 32 may determine if mobile computing device 30 is proximate to secondary device 32 (172). For example, telemetry module 54 of secondary device 32 may send a message to telemetry module 40 of mobile computing device 30 using one or more short range communication protocols (e.g., Bluetooth protocol, NFC protocol, Wi-fi, or the like) and secondary device 32 may determine that mobile computing device 30 is proximate to secondary device 32 when telemetry module 54 of secondary device 32 receives a reply to the message from mobile computing device 30 (“YES” branch of 172). As an example, in response to telemetry module 54 of secondary device 32 sending the message to telemetry module 40 of mobile computing device 30, telemetry module 40 of mobile computing device 30 may send to telemetry module 54 of secondary device 32 an indication that mobile computing device 30 received the message (e.g., an answer to an inquiry within the message, acknowledgement of a reception of the message, or the like) and secondary device 32 may determine that mobile computing device 30 is proximate to secondary device 32 in response to receiving the indication from mobile computing device 30.

Responsive to determining that mobile computing device 30 is proximate to secondary device 32 (“YES” branch of 172), secondary device 32 may determine whether mobile computing device 30 is in a trusted state (174). For example, telemetry module 54 of secondary device 32 may receive a communication message from telemetry module 40 of mobile computing device 30 indicating that a current user of mobile computing device 30 is an authorized user (“YES” branch of 174). As an example, mobile computing device 30 may send to secondary device 32 an indication that mobile computing device 30 determined an input (e.g., tactile, audio, visual, etc.) detected by mobile computing device 30 corresponds with a preconfigured sensor input pattern associated with an authorized user of mobile computing device 30 and secondary device 32 may determine that mobile computing device 30 is in a trusted state in response to receiving the indication that mobile computing device 30 determined the input detected by mobile computing device 30 corresponds with the preconfigured sensor input pattern.

In examples where secondary device 32 determines that mobile computing device 30 is in a trusted state (“YES” branch of 174), secondary device 32 may determine whether secondary device 32 is in a worn state (176). For example, secondary device 32 may determine that secondary device 32 is in a worn state in response to generating sensor data indicating secondary device 32 is in a physical state corresponding to being worn by a user (“YES” branch of 176). Examples of sensor data indicating secondary device 32 is in a physical state corresponding to being worn by a user may include instances where a clasp sensor of secondary device 32 generates sensor data indicating that secondary device 32 is wrapped around a wrist, where a galvanic skin response sensor of secondary device 32 generates sensor data indicating that secondary device 32 is in direct contract with skin, or the like. As another example, a worn state may include instances where a sensor of secondary device 32 generates sensor data indicating a presence of a user, such as, for example, the sensor data indicating the presence of a temperature or temperature range, a heart rate or heart pulse, gait, or the like.

If secondary device 32 determines that secondary device 32 is in a worn state (“YES” branch of 176), secondary device 32 may send payment information for the payment request to payment system 34 (178). For example, in response to determining that mobile computing device 30 is proximate to secondary device 32, that mobile computing device 30 is in a trusted state, and that secondary device 32 is in a worn state, telemetry module 54 of secondary device 32 may send payment information determined by payment module 52 to payment system 34. In this manner, secondary device 32 may send the payment information to payment system 34 without an authentication challenge, thereby reducing the number of steps required to complete the mobile payment, which may result in a better user experience without significantly increasing the risk of abuse by unauthorized persons and financial loss.

On the other hand, if mobile computing device 30 and secondary device 32 are not proximate (“NO” branch of 172), mobile computing device 30 is not in a trusted state (“NO” branch of 174), or secondary device 32 is not in a worn state (“NO” branch of 176), secondary device 32 may initiate an authentication challenge (180). For example, in response to mobile computing device 30 and secondary device 32 not being proximate, secondary device 32 may prompt a user to input a response (e.g., a PIN, a pattern or biometric data (e.g., fingerprint, voice, image, or the like), or the like to an authentication challenge in order to reduce the risk of abuse by unauthorized persons.

Secondary device 32 may determine whether the response to the authentication challenge is satisfied (182). For example, secondary device 32 may receive an indication of a response to the authentication challenge and secondary device 32 may determine whether a payment for the purchase is authorized (e.g., the authentication challenge is satisfied) based on the response to the authentication challenge. As an example, in response to secondary device 32 initiating the authentication challenge, a sensor of secondary device 32 may detect an indication of a touch input (e.g., PIN input by a user, a biometric data, or the like) and secondary device 32 may determine that the authentication challenge is satisfied and that payment for the purchase is authorized based on a comparison of the touch input to a predefined user selected input (e.g., PIN input by a user during a setup of secondary device 32, PIN stored in a cloud computing system, or the like) indicating a match. In response to the authentication challenge being satisfied (“YES” branch of 182), secondary device 32 may send payment information for the payment request (178).

In some examples, secondary device 32 may use a risk level of the purchase to determine whether to initiate an authentication challenge. For example, in response to mobile computing device 30 being proximate to secondary device 32, mobile computing device 30 being in a trusted state, and secondary device 32 being in a worn state, secondary device 32 may determine a low risk level for the payment transaction. On the other hand, in response to mobile computing device 30 not being proximate to secondary device 32 (e.g., outside of a range of a short range communication protocol), mobile computing device 30 not being in a trusted state, or secondary device 32 not being in a worn state, secondary device 32 may determine a high risk level for the payment transaction.

In some examples, secondary device 32 may modify the risk level in response to sensor data generated by sensors of secondary device 32. For example, secondary device may decrease a risk level when sensor data generated by sensors of secondary device 32 indicate a gait similar to a predefined gait (e.g., a gait corresponding to a user of secondary device 32, a predefined gait stored by secondary device 32, a predefined gait stored in a cloud computing device, or the like). On the other hand, secondary device 32 may increase a risk level when sensor data generated by sensors of secondary device 32 indicate a gait different to the predefined gait. As another example, secondary device 32 may increase a risk level for purchases having a high price and secondary device 32 may decrease a risk level for purchases having a low price.

Secondary device 32 may determine whether to send payment information for a purchase without requiring an authentication challenge in further response to a comparison of the determined risk level with a user selected risk level (e.g., received during a setup of secondary device 32, a predefined risk level, a risk level received from a cloud computing device, or the like). As an example, secondary device 32 may send payment information for a purchase when a risk level for the purchase satisfies (e.g., is less than, greater than, etc.) a predefined user selected input without requiring an authentication challenge and secondary device 32 may require satisfaction of an authentication challenge for sending payment information for a purchase when a risk level for the purchase does not satisfy (e.g., is greater than, less than, etc.) a predefined user selected input.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include anon-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the invention have been described. These and other examples are within the scope of the following claims.

What is claimed is:

1. A method comprising:
receiving, by a computerized watch and from a payment system, a payment request for a purchase;
determining, by the computerized watch, whether a mobile device is proximate to the computerized watch;
determining, by the computerized watch, whether the mobile device is in a trusted state;
determining, by the computerized watch, whether the computerized watch is in a worn state; and
responsive to determining that the mobile device is proximate to the computerized watch, that the mobile device is in the trusted state, and that the computerized watch is in the worn state, sending, by the computerized watch and to the payment system, payment information for the purchase.

2. The method of claim 1, further comprising:
responsive to determining that the mobile device is not proximate to the computerized watch, that the mobile device is not in the trusted state, that the computerized watch is not in the worn state, or a combination thereof, initiating, by the computerized watch, an authentication challenge;
receiving, by the computerized watch, an indication of a response to the authentication challenge; and
determining, by the computerized watch and based on the response to the authentication challenge, whether a payment for the purchase is authorized,
wherein sending the payment information is in response to determining that the payment is authorized.

3. The method of claim 2, wherein:
the response to the authentication challenge includes an indication of a touch input detected by the computerized watch, and
determining whether the payment for the purchase is authorized is based on a comparison of the touch input to a predefined user selected input.

4. The method of claim 1, further comprising:
determining, by the computerized watch, a risk level of the purchase,
wherein sending the payment information is further in response to determining that the risk level of the purchase satisfies a risk threshold.

5. The method of claim 1, wherein determining that the mobile device is proximate to the computerized watch comprises:
sending, by the computerized watch, to the mobile device, and using one or more short range communication protocols, a message; and
receiving, by the computerized watch and from the mobile device, an indication that the mobile device received the message.

6. The method of claim 1, wherein determining that the mobile device is in the trusted state comprises:
receiving, by the computerized watch and from the mobile device, an indication that the mobile device determined an input detected by the mobile device corresponds with a preconfigured sensor input pattern associated with an authorized user of the mobile device.

7. The method of claim 1, wherein determining that the computerized watch is in the worn state comprises:
generating, by the computerized watch, sensor data; and
determining, by the computerized watch and based on the sensor data, whether the computerized watch is in a physical state corresponding to being worn by a user.

8. A computerized watch comprising:
one or more processors;
one or more sensors configured to generate sensor data;
one or more communication units; and
at least one module operable by the one or more processors to:
receive, from a payment system via the one or more communication units, a payment request for a purchase;
determine whether a mobile device is proximate to the computerized watch;
determine whether the mobile device is in a trusted state;
determine, based on the sensor data, whether the computerized watch is in a worn state; and
responsive to determining that the mobile device is proximate to the computerized watch, that the mobile device is in the trusted state, and that the computerized watch is in the worn state, send, to the payment system via the one or more communication units, payment information for the purchase.

9. The computerized watch of claim 8, wherein the at least one module is further operable by the one or more processors to:
responsive to determining that that the mobile device is not proximate to the computerized watch, that the mobile device is not in the trusted state, that the computerized watch is not in the worn state, or a combination thereof, initiate an authentication challenge;
receive an indication of a response to the authentication challenge;
determine, based on the response to the authentication challenge, whether a payment for the purchase is authorized; and
responsive to determining that the payment is authorized, send, to the payment system via the one or more communication units, the payment information for the purchase.

10. The computerized watch of claim 9, wherein:
the response to the authentication challenge includes an indication of a touch input detected by the one or more sensors of the computerized watch, and
the at least one module is further operable by the one or more processor to determine whether the payment for the purchase is authorized based on a comparison of the touch input to a predefined user selected input.

11. The computerized watch of claim 8, wherein the at least one module is further operable by the one or more processors to:
determine a risk level of the purchase; and
send the payment information in further response to determining that the risk level of the purchase satisfies a risk threshold.

12. The computerized watch of claim 8, wherein the at least one module is further operable by the one or more processors to:
send, to the mobile device via the one or more communication units and using one or more short range communication protocols, a message;
receive, from the mobile device via the one or more communication units, an indication that the mobile device received the message; and
responsive to receiving the indication that the mobile device received the message, determine that the mobile device is proximate to the computerized watch.

13. The computerized watch of claim 8, wherein the at least one module is further operable by the one or more processors to:
receive, from the mobile device via the one or more communication units, an indication that the mobile device determined an input detected by the mobile device corresponds with a preconfigured sensor input pattern associated with an authorized user of the mobile device; and
responsive to receiving the indication that the mobile device determined the input detected by the mobile device corresponds with the preconfigured sensor input pattern, determine that the mobile device is in the trusted state.

14. The computerized watch of claim 8, wherein the at least one module is further operable by the one or more processors to:
determine, based on the sensor data, whether the computerized watch is in a physical state corresponding to being worn by a user; and
responsive to determining that the computerized watch is in the physical state corresponding to being worn, determine that the computerized watch is in the worn state.

15. A computer-readable storage medium encoded with instructions that, when executed, cause one or more processors of a computerized watch to:
receive, from a payment system, a payment request for a purchase;
determine whether a mobile device is proximate to the computerized watch;
determine whether the mobile device is in a trusted state;
determine whether the computerized watch is in a worn state; and
responsive to determining that the mobile device is proximate to the computerized watch, that the mobile device is in the trusted state, and that the computerized watch is in the worn state, send, to the payment system, payment information for the purchase.

16. The computer-readable storage medium of claim 15, that, when executed, further cause the one or more processors of the computerized watch to:
responsive to determining that that the mobile device is not proximate to the computerized watch, that the mobile device is not in the trusted state, that the computerized watch is not in the worn state, or a combination thereof, initiate an authentication challenge;
receive an indication of a response to the authentication challenge;
determine, based on the response to the authentication challenge, whether a payment for the purchase is authorized; and
responsive to determining that the payment is authorized, send, to the payment system, the payment information for the purchase.

17. The computer-readable storage medium of claim 16, wherein:
the response to the authentication challenge includes an indication of a touch input detected by the computerized watch, and
the instructions further cause the one or more processors of the computerized watch to determine whether the payment for the purchase is authorized based on a comparison of the touch input to a predefined user selected input.

18. The computer-readable storage medium of claim 15, that, when executed, further cause the one or more processors of the computerized watch to:
determine a risk level of the purchase; and
send the payment information in further response to determining that the risk level of the purchase satisfies a risk threshold.

19. The computer-readable storage medium of claim 15, that, when executed, further cause the one or more processors of the computerized watch to:
send, to the mobile device and using one or more short range communication protocols, a message;
receive, from the mobile device, an indication that the mobile device received the message; and
responsive to receiving the indication that the mobile device received the message, determine that the mobile device is proximate to the computerized watch.

20. The computer-readable storage medium of claim 15, that, when executed, further cause the one or more processors of the computerized watch to:
receive, from the mobile device, an indication that the mobile device determined an input detected by the mobile device corresponds with a preconfigured sensor input pattern associated with an authorized user of the mobile device; and
responsive to receiving the indication that the mobile device determined the input detected by the mobile device corresponds with the preconfigured sensor input pattern, determine that the mobile device is in the trusted state.
